(19) United States
(12) Patent Application Publication
(10) Pub. No.: US 2004/0184105 A1
(43) Pub. Date: Sep. 23, 2004

(54) Color and black and white pre-rip print-job splitting

(75) Inventor: Andrew R. Ferlitsch, Camas, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/393,953

(22) Filed: Mar. 21, 2003

(51) Int. Cl. G06K 15/02; G06F 3/12; H04N 1/52; H04N 1/40

(52) U.S. Cl. 358/2.1; 358/1.13

(57) ABSTRACT

A system and methodology for splitting mixed-mode imaging jobs through introducing and employing a pre-raster-image-processing (RIP) splitter in the region intermediate the location in a imaging system where an imaging job is created, and that region downstream in that organization wherein RIP takes place.

### BACKGROUND AND SUMMARY OF THE INVENTION

The present invention relates to imaging-job splitting, such as print-job splitting. In particular, and speaking in the imaging context specifically of printing, it pertains to the splitting of a mixed-mode print job, such as a mixed black-and-white and color print job, into plural, (such as two) split, single-mode, output print jobs, with splitting occurring at a location which is upstream in a printing (imaging) environment from where raster imaging processing (RIP) takes place.

As will become apparent, the system and methodology of this invention can be practiced with various different kinds of plural-mode imaging jobs. Thus, it should be understood that illustrative references made herein to print, printing, printer, and printing device(s), or the like, are intended to be understood to be references more broadly to the larger field of computer imaging which includes processes such as printing, faxing, scanning, copying, and others, etc. Accordingly, unless an indication to the contrary is provided, either directly, or in context, such references to print or printing, etc., should be read also to be references to this broader field of imaging. Also, while a preferred embodiment of, and manner of practicing, the invention, are described herein in conjunction with splitting a dual-mode printing job, such as a black-and-white and color printing job, the reader should understand that the same illustrated principles, modalities and structures are usable just as well in other kinds of plural-mode imaging jobs, including imaging jobs which may include more than just two different modes.

There are many reasons for wanting to split a plural-mode printing job into appropriate single-mode printing jobs. In the case of a mixed black-and-white and color printing job, it is traditionally the case that, because of the presence of color imagery on all or part of one or more pages in such a job, the entire job is essentially fed through a color printing driver, and ultimately to a color printer. This traditional job routing thus places the entire job at the “mercy” of the higher costs and lower through-put speeds that are traditionally associated with color-printing devices and procedures. Various prior art approaches aimed at job-splitting to avoid these and other mixed-job issues have not been entirely satisfactory for a large variety of reasons. These reasons usually make their appearances in the forms of higher job costs and lower job efficiencies, and often also in the form of finished jobs, wherein at least one of the mixed modes is not performed with optimum results, i.e. is compromised in some manner. Also, it may be difficult and/or too expensive, even if possible, to retrofit existing printing (imaging) systems and equipment with job-splitting capability.

The present invention offers a system and a methodology which address these issues squarely, and which propose an approach whereby optimum printing (imaging) results are achievable following relatively easily implemented, and quite retrofitable, splitting of a job.

According to a preferred embodiment of and manner of practicing the invention, what is proposed here, very simply and directly stated, is that a mixed-mode job be split by an appropriate splitter which is disposed in an imaging system downstream from where the job per se is generated, and upstream from where, in that system, raster imaging processing (RIP) takes place. The proposed resolution of the job-splitting issue is thus completely, and in very simple terms, so expressed. Thus, the present invention springs from the concept of introducing, in any suitable manner, which may otherwise be an entirely conventional manner, structure and processes in an imaging system in a location which will “intersect” the job stream through that system in a region which is intermediate the place where a job is created, such as in the site of an imaging driver, and a region downstream in the system wherein RIP takes place.

The various features and advantages of this invention, thus simply stated in respect of its basic structure and methodology, will become more fully apparent as the description which now follows, presented chiefly in the specific subfield of printing, is read in conjunction with the accompanying drawings.

### DESCRIPTION OF THE DRAWINGS

FIG. 1 is a high-level block/schematic diagram, partly fragmentary, illustrating a printing (imaging) system and methodology which are constructed, and which operate, in accordance with a preferred and best mode embodiment and manner of practicing the present invention. For the purpose if illustration herein, what is shown specifically in FIG. 1, as well as in the other drawings herein, is an illustration of the present invention in the context of a printing environment—one of the specific environments embraced under the term “imaging”.

FIG. 2 is a block/schematic diagram illustrating separation of a mixed black-and-white and color print job into two sets of logical pages with one relating ultimately to an output, “split” color job, and the other relating ultimately to an output, “split” black-and-white job.

FIG. 3 is a schematic diagram illustrating duplex page layout involving a situation with color and black-and-white information contained on the same job sheet.

FIG. 4 is a schematic illustration of booklet page layout practice in accordance with practice of the invention.

FIG. 5 illustrates a print-job finishing operation—namely stapling.

FIG. 6 illustrates a practice referred to herein as PJL modification for heterogeneous devices.

FIG. 7 is a schematic drawing illustrating implementation of the invention in relation to controlling a “job release”.

FIG. 8 is a schematic diagram illustrating implementation of the invention with respect to the utility of so-called “proof sheets” regarding a job.

### DETAILED DESCRIPTION OF THE INVENTION

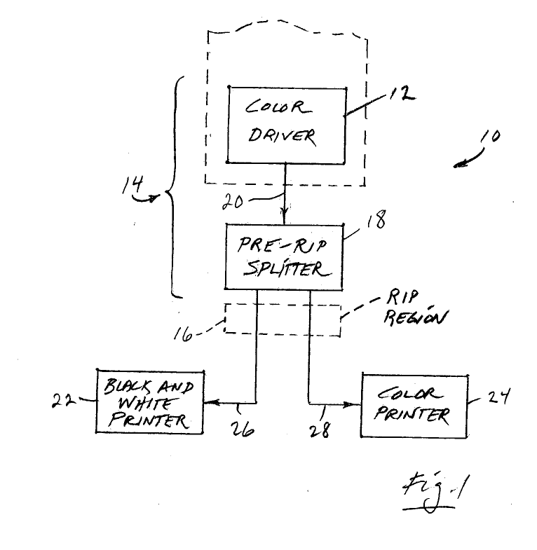

Turning attention now to the drawings, and beginning with FIG. 1, indicated generally at 10 are a preferred system, and a related methodology, which are constructed, and which perform, in accordance with a preferred and best mode implementation and manner of practicing the present invention. Speaking in systemic terms, system 10 is illustrated herein in the form of the printing system—one of the previously mentioned categories of imaging systems. This system includes a color printer driver 12, which forms part of what is referred to herein as an upstream part 14 within system 10, a raster image processing (RIP) region 16, which is downstream from driver 12 in system 10, and a pre-RIP splitter 18, which is operatively interposed driver 12 and RIP region 16. Splitter 18 is also referred to herein as splitting structure.

An operative connection 20, which is shown extending from driver 12 to splitter 18, through which connection a mixed-mode print job is fed from driver 12 to the splitter, functions herein as the downstream side of driver 12. Driver 12 per se is also referred to herein as an engaging structure.

Also shown in FIG. 1 are two destination printers, or printing devices, also referred to as imaging devices, 22, 24 which are, respectively, a black-and-white printer and a color printer. Connections 26, 28 are shown effectively interconnecting the lower, or output, side of splitter 18 and printers 22, 24, respectively, with these connections shown schematically passing through RIP region 16. Where connections 26, 28 connect with splitter 18, they are referred to herein collectively as output delivery structure which functions to deliver to RIP region 16 split, single-mode “output jobs coming from splitter 18.

It should be noted that, while RIP region 16 is shown in FIG. 1 as a separate, free-standing and external component/processing region, this RIP region could just as well be resident within printers 22, 24.

In accordance with the special behaviors that are offered the present invention, jobs which are delivered to printers 22, 24 are properly configured with correct print-control commands, whereby they become optimally handled by these printers. Placed, as it is in accordance with this invention, intermediate the region where a print (imaging) job is created, such as in the vicinity of color driver 12 in FIG. 1, and RIP region 16, the pre-RIP splitter structure and methodology of this invention neatly address the various prior art issues mentioned earlier. And, the invention does this in a manner which is relatively easy to implement, and which can also be implemented under many retrofit conditions.

The remaining drawing figures are now discussed, on a figure-by-figure basis, to give further illustration to implementation and practice of this invention, including illustration how the invention's features are compatible with other practices, such as proofing and job-releasing.

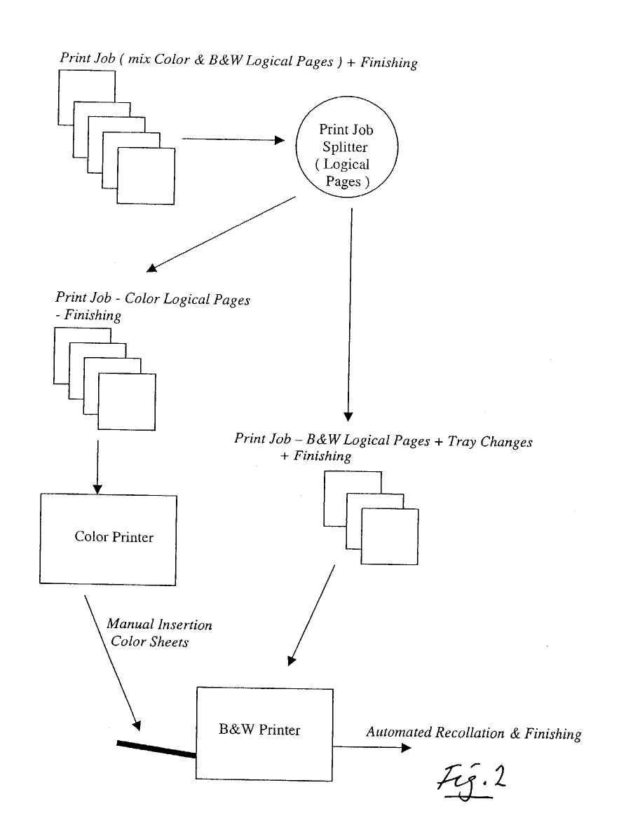

Shown in FIG. 2 is a representation of the operation of this invention in relation to the separation of a mixed color and black-and white print job into two logical-page assemblies of two single-mode jobs—namely, a black-and white job, and a color job. Here, the mixed job is analyzed prior to RIP. Generally, such a mixed print job is in a PDL format (e.g., PCL, Postscript, ESC/P), has been generated by a printer driver, and contains additional job control information, such as PJL, to express assembly and finishing requirements, such as duplex and stapling. The mixed print job may also be in non-print formats, such as a document (e.g., MS-Word), or image (i.e., TIFF) format, typically used in direct printing. In such a case, the native format of the document or image data is the input print data to the printing device. Generally speaking, with regard to direct printing jobs, the document or image data is prepended by print-job requirements.

This pre-RIP analysis herein functions, in accordance with the invention, as the logical page splitter, and can be performed by any suitable component added to the print subsystem upstream relative to where the RIP process occurs. For example, the logical page splitter can be implemented as a backend process (a) in a printer driver, (b) in a print spooler, (c) in a print processor, (d) in a port manager, (e) in a custom component (e.g., a print assist) added to the print subsystem between the printer driver and port manager,(f) in a component within a network print server, (g) in a component within a RIP server,(h) in a third-party component added along the transmission path of the print job, and (i) in any suitable component positioned upstream from the RIP region within the printing system. The logical page splitter separates the print job into three components:

1. Print Job Requirements

2. Logical Color Pages

3. Logical Black-and-White Pages

4. End of Job

In the case of a print job that uses PJL to define the print job requirements, the print job requirements would include all the PJL statements that start after the print job preamble (e.g., UEL and printer reset), and would continue onto the PJL ENTER LANGUAGE=<PDL>, where the <PDL> is the name of the page description language used to describe the print data. Below is an example:

Esc%-12345X
EscE
@PJL COMMENT @PJL JOB NAME=“...”
@PJL SET PAGEPROTECT=OFF
@PJL SET RET =ON
@PJL SET ECONOMODE=OFF
@PJL SET OUTTRAY=TRAY3 Print Job Requirements
@PJL SET RESOLUTION=600
@PJL SET MEDIASOURCE=AUTOMATIC
@PJL SET ORIENTATION=PORTRAIT
@PJL SET DUPLEX=OFF
@PJL SET BINDING=SHORTEDGE
@PJL ENTER LANGUAGE=PCL
<print data>

The End of Job portion of the print job generally follows the print data, and identifies the end of a RIP and/or spool.

The following is an example:

<print data>
EscE
Esc%-12345X

The spool file may also contain several RIPs. The application of this invention would then be applied to each RIP separately, and the associated job reconstructed accordingly.Below is an example of a multi-RIP spool file.

| | |
|---|---|
| Esc%-12345X | Start of 1s1 RIP and Spool |

EscE
@PJL COMMENT
@PJL JOBNAME=“Banner Page”
@PJL ENTER LANGUAGE=PCL
<print data for Banner Page>
EscE

| | |
|---|---|
| Esc%-12345 | End of 1s1 RIP and start of 2nd RIP |

EscE
@PJL COMMENT
@PJL JOBNAME=“document.doc”
@PJL ENTER LANGUAGE=PCL
<print data document.doc>
EscE

| | |
|---|---|
| Esc%-12345 | End of 2nd RIP and Spool |

The print data would then be analyzed according to the native format of the print data, such as PCL, Postscript, ESC/P, TIFF, PDF, and MS-Word, and the print data broken into logical pages, with the following considerations:

1. The start and end of a page would be based on the native language.

2. All page layout information (e.g., orientation, media source, etc) would be retained with the page.

3. Page order in job sequence.

4. Persistent page data.

In the latter case of persistent data, some native languages have constructs that persist across page boundaries, and therefore this kind of data must be associated with all of the relevant “persist” pages. For example, in PCL5e, the page orientation command may appear on the first page, and may persist on every subsequent page until reissued. Any well-known manner for dealing with this situation, such as replication, may be employed.

The identified logical pages are then sequenced to form the physical printed sheets according to the page layout information and job assembly information. For example, in a normal order duplex print job using the same input media, each pair of logical pages, starting with page one, in sequential order would be laid out and grouped into sheets.

Depending on the relevant print layout and options, the pages might not necessarily be laid out in sequential page order. As an illustration, if the second page in a duplex job was of a different input media, a physical page eject would occur after the first page, and the second page would appear as the odd page on the next sheet. Other job assembly options can produce orderings that are not sequential, such as booklet printing.

Once the logical pages are ordered and grouped, two copies of print data are assembled according to the previously mentioned layout—one for the color job, and one for the black-and white job. In the color job, each logical page that is black-and-white is replaced with a blank page, but otherwise retains all media input information. If a sheet contains only black-and-white logical pages, the sheet is removed from the job.

Just the opposite approach is implemented for the black-and-white job, where all of the color logical pages are replaced with only blank pages, except that blank sheets are not removed. In addition, the black-and-white print job contains the print job control instructions for finishing, which were excluded from the color print job.

One should note that if the job assembly has a non-sequential page ordering, the logical pages may again be further reordered, or new page-control commands, such as page resets, may be inserted into the job in order not to disturb the proper production of sheets by the printer when one or more intermediate sheets, containing only blank logical pages, have been removed. The color print job is then prepended with the print job requirements, with the exception that all finishing options are removed (e.g., stapling, hole punch, folding, etc.), and the color print job is de-spooled to the color printing device. Further, if the print job control commands (e.g., PJL) are not compatible with the color printer, the print-job control commands are also modified to be compatible with the color printer.

Once the color job is printed by the color printer, a user manually removes the sheets, and without any reshuffling or re-collation, inserts the sheets into a secondary input tray of the black-and-white printer. The sheets are inserted in such a manner (face and direction), that when the black-and-white printer pulls the color and blank sheets from the primary and secondary input trays, the merged output will be in the correct face and print direction. Further, the invention may display to the user a dialog informing the user of the face/direction to insert the stack, or produce a sheet with appropriate instructions as part of the output job, or produce proof sheets to verify correct insertion.

If a sheet print job sent to the black-and-white printer contains one or more logical color pages, a media input source instruction is added to the first logical page corresponding to the sheet to pull from the secondary input tray which contains the color job output.

After the color job output is inserted into the secondary input tray, the black-and-white job may be released, either manually by the user, such as an “OK” response to a dialog from the logical page splitter, or by an appropriate, conventional release mechanism.

Once the black-and-white job starts printing, sheets are then pulled either from the primary, or other designated trays, or the secondary input tray, according to the media input instructions; whereby, the job pulls sheets containing at least one color-printed logical page from the secondary input in the appropriate sequence.

In an alternate method, the roles and construction of the color and black-and-white split jobs are reversed.

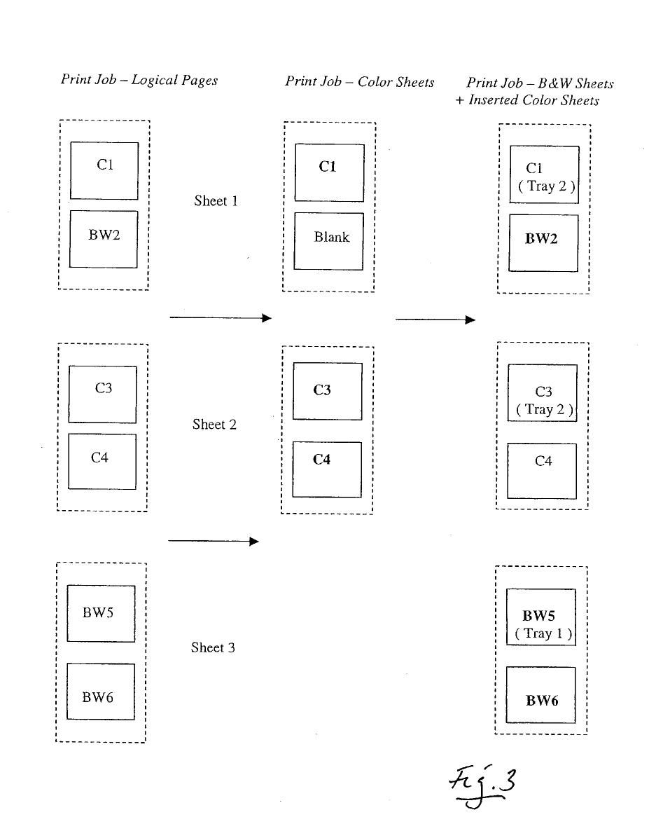

FIG. 3 provides an example of handling a duplex situation, with certain pages in a mixed print job containing both color and black-and-white information. As shown here, sheets in the job are laid out as follows:

Sheet 1 Color (page 1) black-and-white (page 2)

Sheet 2 Color (page 3) Color (page 4)

Sheet 3 B& W (page 5) black-and-white (page 6)

The color print job, according to the invention, would be constructed as follows:

Sheet 1 Color (page 1) Blank (page 2)

Sheet 2 Color (page 3) Color (page 4)

One should note here that no color logical page has appeared as sheet 3. It was removed from the color print job.

The B&W print job, according to the invention, would be constructed as follows, where tray 1 is the primary tray and tray 2 is the secondary tray containing the printed color job:

Sheet 1 Blank (page 1, tray 2) black-and-white (page 2)

Sheet 2 Blank (page 3, tray 2) Blank (page 4)

Sheet 3 B&W (page 5, tray 1) black-and-white (page 6)

In the above example, the blank logical pages in the black-and-white print job correspond to the printed color logical pages on the sheets obtained from the secondary media input.

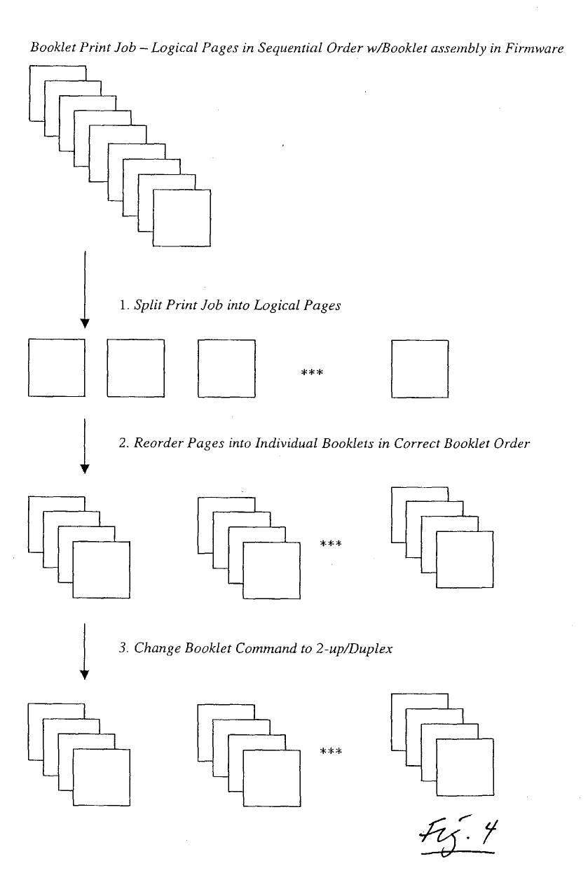

FIG. 4 illustrates the implementation of the invention on regarding a booklet job. In this case, as well as in other assembly cases that have non-sequential page ordering, a sequential split, and ordering of the job, as described above, would not result in the correct assembly when pages are finally merged. To obtain a correct assembly in the final merge, the following steps are taken:

1. The print job is split into logical pages, as described above.

2. The logical pages are sequenced (i.e., reordered) according to their booklet ordering into physical sheets.

3. The job assembly command for booklet is removed and replaced with 2-up/duplex commands.

4. The reordered logical pages and modified job assembly commands are the split into their corresponding color and black-and-white jobs, as described above.

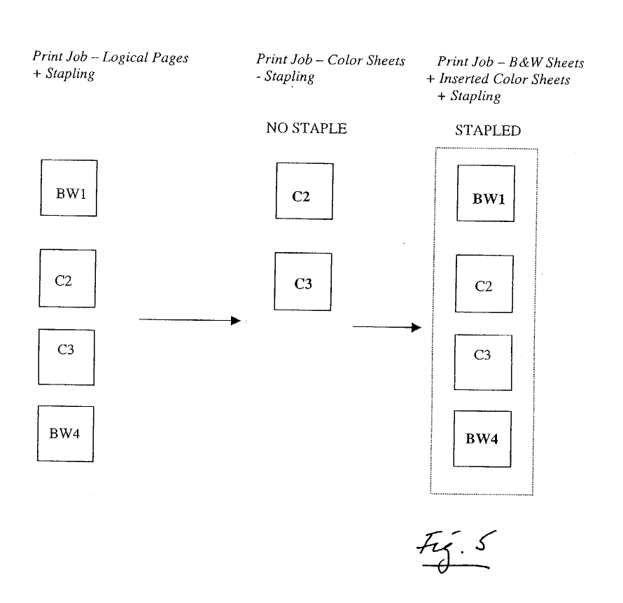

In FIG. 5, implementation of the invention is illustrated in relation to a finishing option—namely, stapling. Finishing options generally take the forms of binding operations that are performed by a finishing device which is attached to a printing device. This illustration for stapling generally applies to any and all finishing options, such as hole-punching, folding, etc.

All finishing options are removed from the color job, and the color job is output in unfinished format. The finishing options are left in the black-and-white print job. Thus when the black-and-white job is printed and merged with the printed color logical pages and assembled, the final output is sent to the finisher, and is finished, in the same manner as if the job had never been split.

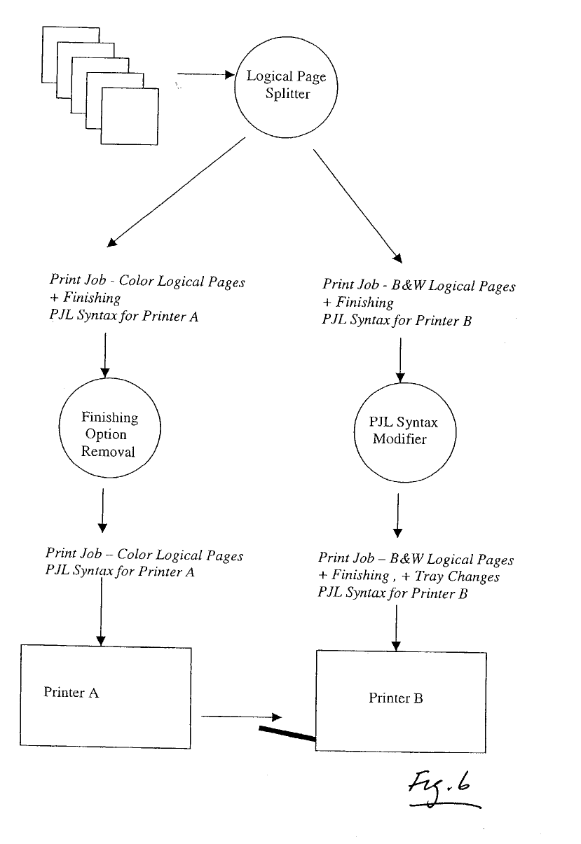

FIG. 6 describes implementation of the invention where one or both of the targeted printing devices' appropriate print-job control data is non-compatible with the source (e.g., printer driver)-generated print-job controls. The print-job controls generally specify job assembly, finishing, input/output trays, copy count, collation, resolution, and other job-wide operations. Here, print-job control commands are parsed to determine the option and corresponding option selections, based on the known syntax/semantics of the source. The print job control commands are then converted to the option and corresponding option selections, based on the known syntax/semantics of each destination.

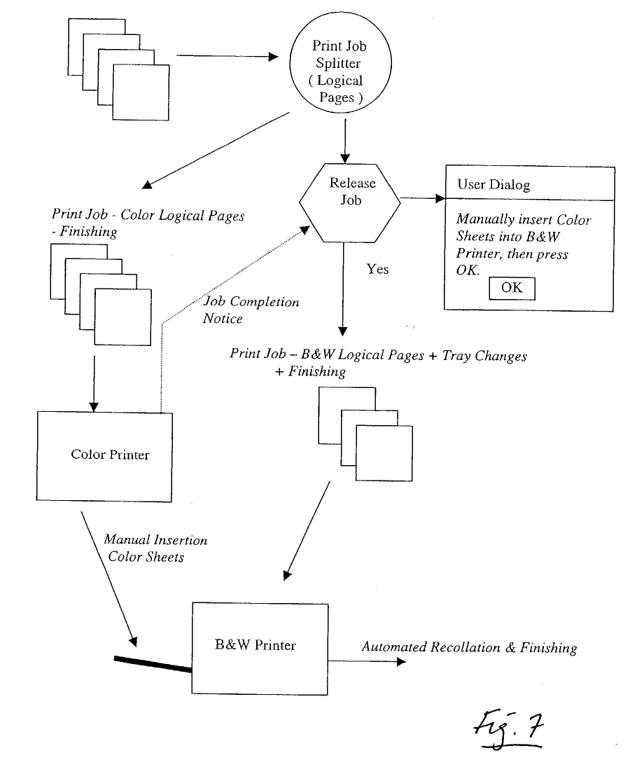

FIG. 7 illustrates job completion and job release according to practice of the invention. When, in the practice examples being explored herein, a print job is split into a color job and a black-and-white job, the black-and-white job must be held until after the color job has been output, and been inserted into the secondary tray of the black-and-white printer. There are several mechanisms by which this can be accomplished.

In one method, the logical page splitter holds the black-and-white split job and waits on a user response to a dialog. After the color job has been output, and inserted into the secondary input tray of the black-and-white printer, the user then responds to the dialog (e.g., depresses the “OK” button) in a manner that instructs the logical page splitter to release the black-and-white print job to the black-and-white printer.

In another method, the logical page splitter has a bi-directional communication capability with either or both the color and/or the black-and-white printer. In the case of the color printer, the color printer sends a job-completion notification back to the logical page splitter, indicating that the color job has been output successfully. The Sharp Corporation's NJR protocol and SMON @ printer monitoring application are examples of products that perform this function. Once a job-completion notification is received, the logical page splitter then displays a dialog, notifying the user, and prompting that user to load the color output into the black-and-white printer. The logical page splitter can then initiate either a poll or listening process for a response or a message indicating that the secondary tray has been loaded.

In yet another method, the black-and-white printer could have both an internal print queue, and interactive job capabilities. In this case, the logical page splitter could de-spool the black-and-white print job to the internal queue of the black-and-white printer with an instruction to hold the job, while de-spooling the color job to the color printer. Once the user has loaded the color job output into the secondary input tray of the black-and-white printer, the black-and-white job could then be released from a “front panel” control by the user.

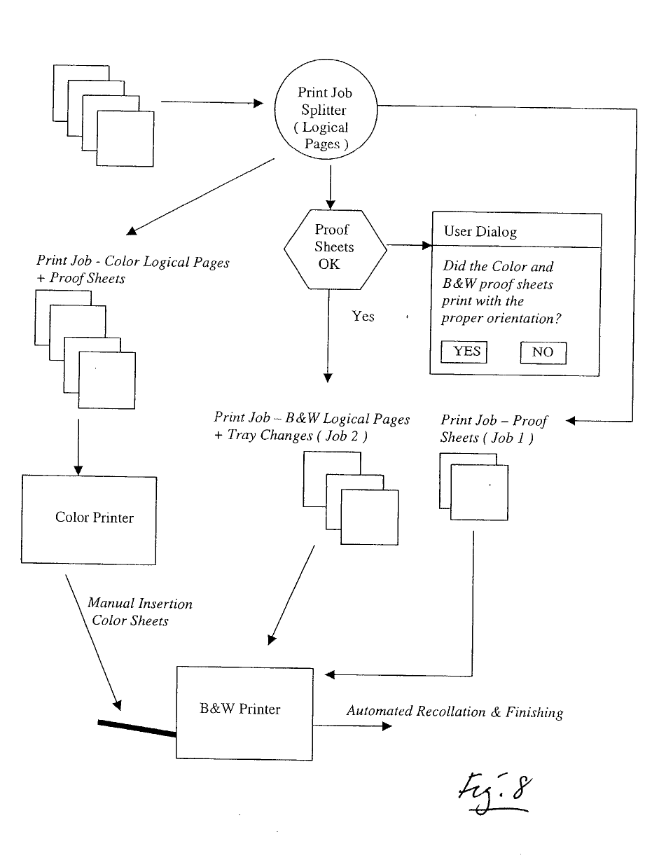

Turning attention now to FIG. 8, this drawing figure graphically describes implementation of the invention in relation to proof sheets. In this setting, both the color and the black-and-white jobs are prepended with one or more proof sheets. These proof sheets are constructed in a manner to test that a user has correctly inserted, with respect to both facing and direction, pages into the secondary tray of the black-and-white printer. Preferably, one or both sides of such proof sheets will contain printing instructions to indicate the direction and facing for printing. The procedure would work, for example by pulling at least one sheet from the color job's secondary input tray in the black-and-white printer, and at least one sheet from the primary input tray, which is then printed, with corresponding, dual, or more, sheets then output. The user would then remove the sheets from the tray and examine the markings for correct facing and orientation when merged together. If correct, the user would then release the remainder of the job. Otherwise, the user would make the necessary corrections.

Thus, the system and methodology of this invention uniquely address the issue of mixed-mode imaging-job splitting by proposing an arrangement, fundamentally, where such splitting takes place in the region between where a job is created, and where raster image processing takes place. And, while a preferred and best mode embodiment and manner of practicing the present invention, a number of illustrations thereof, and several variations, have been illustrated and described herein, it is appreciated that other variations and modifications may be made without departing from the sprit of the invention. It is intended that all such variations and modifications will come within the scope of the present invention.

I claim:

1. A method of splitting a mixed-mode print job in a printing system which includes a raster image processing (RIP) region, said method comprising,
at a location in the system which is upstream from the RIP region engaging such a mixed-mode print job, and
following said engaging, splitting the engaged print job into plural, single-mode print jobs for delivery as input to the RIP region.

2. Splitting a mixed-mode print job in a printing system having (a) a printer driver with a downstream side, and (b) downstream from such driver, a raster image processing (RIP) region, said splitting comprising
furnishing a mixed-mode print job as an output from the downstream side of the printer driver,
at a location which is upstream from the RIP region, receiving and then splitting that mixed-mode print-job output into plural, single-mode print jobs, and
following said receiving and splitting, delivering the split print job to the RIP region.

3. Apparatus for splitting a mixed-mode print job in a printing system which includes a raster image processing (RIP) region, said apparatus comprising
engaging structure disposed upstream from the RIP region for engaging such a mixed-mode print job,
splitting structure operatively interposed said engaging structure and the system RIP structure, operable to split, into plural, single-mode print jobs, a mixed-mode print job engaged by said engaging structure, and
split output delivery structure operatively interposed said splitting structure and the system RIP structure, operable to deliver the split print jobs to the system RIP region.
